(19) United States
(12) Patent Application Publication
(10) Pub. No.: US 2003/0084135 A1
(43) Pub. Date: May 1, 2003

(54) Middleware for communications networks

(76) Inventor: Sanjai Narain, Madison, NJ (US)

Correspondence Address: Orville Cockings, Esq., Telcordia Technologies, Inc., 445 South Street, Morristown, NJ, 07960, US

(21) Appl. No.: 09/966,136

(22) Filed: Sep. 28, 2001

(51) Int. Cl. G06F 15/173

(52) U.S. Cl. 709/223

(57) ABSTRACT

Method and system wherein end-to-end service requirements are reduced to intermediate abstractions. The intermediate abstractions representing data structures and relationships relating to configuration parameters settings on and between the devices which necessarily must be provisioned to support the end

### FIELD OF THE INVENTION

The invention is related to automated systems for provisioning communications networks and diagnosing errors in such networks, and in particular to a method and system for mechanizing the provisioning of such networks and diagnosing errors in such networks.

### BACKGROUND

Communication networks are designed and built for the provision of end-to-end services to clients connected via such networks. In order to support any given service between two or more end clients certain global end-to-end functional requirements of the network must be met. For example, in order to connect two clients a physical path between the two communicating end clients must be established. In addition, functional quality of service requirements that depend on the type of service must also be met. Ultimately each functional requirement needed to support a given service must be translated to a configuration requirement on an element, e.g., a specific functional equipment entity, in the network. For example, in establishing an end-to-end path between clients several elements or devices along a path must be properly configured, i.e., setting certain parameter on each device to certain values. More specifically, if an Asynchronous Transfer Mode switch is an element in the path, that switch has to be properly configured so that signals entering an input port are switched or routed to the proper output port. In addition, if there are end-to-end quality of service requirements the switch would have allocated the appropriate amount of bandwidth to support the end-to-end quality of service requirement. In short, the successful provision of services within any given network is usually translated into a set of functional requirements that are in turn used to set the configuration on the elements that implement the service. Configuration is a fundamental operation for integrating devices to implement end-to-end services.

During normal operation of the communication network the configuration of elements is usually static. That is, absent a fault or disaster, an element retains the setting it was configured to. Nonetheless, even without a fault or disaster present, in some instances services do not work or do not work as expected due to configuration errors on the elements. Configuration errors are frequent because transforming end-to-end service requirements into configurations is inherently difficult; in realistic networks there are many devices, configuration parameters, values, protocols, and requirements. When services do not work or do not work as intended due to configuration errors it becomes a large and tedious task to determine the cause of such service failures. Adding to the tedium and uncertainty in today's network is the fact that a large part of today's process of provisioning the devices in a network and determining the causes of end-to-end service failures due to configuration errors relies heavily on human intuition and interpretation.

Of utility then are methods and systems for provisioning devices in a network to support an end-to-end service requirement without the prior art reliance on human interpretative and intuitive skills. Also of utility are methods and systems for determining or diagnosing configuration errors using a mechanized process that does not rely on human intuition and interpretation.

### SUMMARY

My invention is a method and system for implementing end-to-end service or functional requirements that overcomes the shortcomings of the prior art.

In accordance with an aspect of my invention method an end-to-end service or functional requirement is decomposed or translated into a set of intermediate abstractions or requirements. These abstractions are represented by data structures and relationships within each particular protocol domain that needs to be instantiated to support the end-to-end requirement. The intermediate abstractions themselves form vendor neutral requirements that represent instructions that are directly related to settings of configuration parameters of devices that support or implement the end-to-end requirements in the network.

In accordance with another aspect of my invention the set or collection of library requirements representing an end-to-end service may then be compiled by a provisioning function or engine into configuration settings on each of the devices in the network that need to be provisioned to support the service or function. These settings are stored in a configuration database. A diagnosis function or engine is executed whereby the configuration settings resulting from the provisioning engine are checked for consistency against the library requirements. If the configuration settings across all the devices are found to be consistent, then the devices are set to the parameters or settings residing in the configuration device. If an inconsistency is found the method repeats the process starting with decomposition of the end-to-end requirement(s).

### BRIEF DESCRIPTION OF THE DRAWINGS

FIG. 1 depicts an exemplary functional middleware architecture in accordance with the present invention;

FIG. 2 there is shown the method steps for decomposing or translating an end-to-end requirement into a set of library requirements;

FIG. 3A illustrates the general method steps of the present invention;

FIG. 3B depicts an exemplary system in accordance with the present invention;

FIG. 4A is a sample network unto which certain services need to implemented;

FIG. 4B depicts the network that should result after the services are implemented on the network of FIG. 4A; and

FIG. 4C illustratively depict the relationships in a configuration database in accordance with an aspect of my invention.

### DETAILED DESCRIPTION

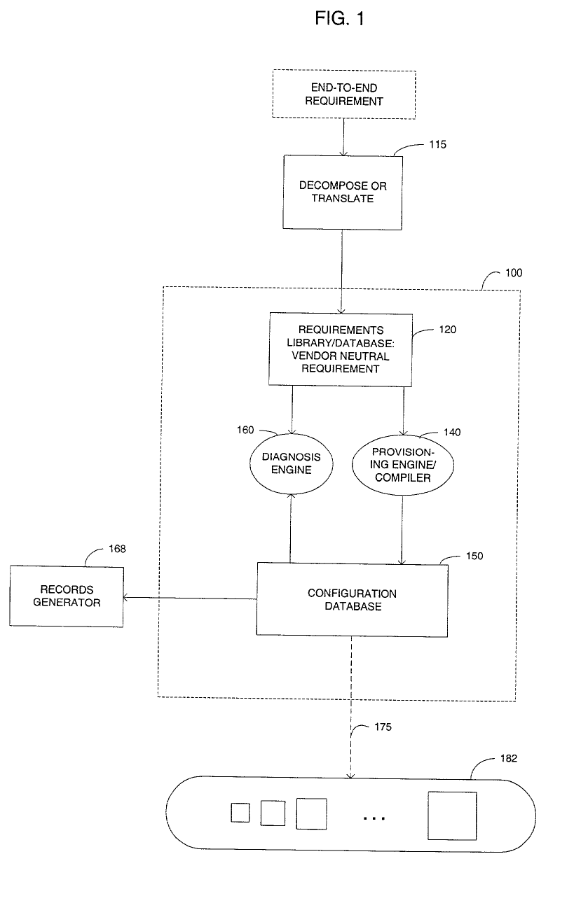

Turning now to FIG. 1 there is shown an exemplary functional middleware architecture 100 in accordance with the present invention. In accordance with my inventive system and method an end-to-end service or functional requirement 110 is decomposed or translated 115 into vendor neutral requirements residing in library or database 120. Provisioning engine or compiler 140 compiles requirements in requirements database 120 into detailed device configuration commands which are stored in configuration database 150. Configuration database 150 is thereby populated with vendor neutral configuration parameters. Diagnosis engine 160 determines if the end-to-end service requirements specified using the library requirements are true given the parameters contained in configuration database 150. The diagnosis engine generates a record via record generator 168 detailing the results of its determination. The vendor neutral requirements may then be used by other network processes to provision the actual devices in the network as is depicted by dotted line 175.

An end to end service or functional requirement 110, in general, represents a plan to create or instantiate either a service or functional requirement in a communications network. These plans typically contain high level abstractions associated with distributed algorithms or protocols, relationships between these protocols, and the operations that need to be performed to instantiate these protocols. These end-to-end functional requirements must ultimately be translated into device configuration commands. Currently, the task of translating the end-to-end requirements is largely manual. As a result configuration errors are frequent. For example, service or function creation and management can be very inefficient and cause security breaches.

In accordance with an aspect of my invention the end-to-end requirements are decomposed or translated into vendor neutral requirements contained in requirements database 120. The requirements in database 120 represent global constraints between configurations parameters of different devices, such as routers and their interfaces, deployed in a network. The end-to-end requirements are specified as a conjunction of the different global constraints.

The requirements database or library 120 formalizes the notion of a correct configuration for all common distributed algorithms or protocols in an application domain. For each distributed algorithm a group of devices must be configured to achieve a joint goal. The joint goals form a set of goals that need to be met to meet the end-to-end requirement. Whether the devices achieve a joint goal depends on the configuration of the devices. Thus, the devices are considered to be correctly configured if they can, in fact, achieve that goal. However for a group of devices to achieve their joint goal, a number of intermediate abstractions, spanning multiple devices and configuration parameters must be set up via configuration steps. Intermediate abstractions are of two types: (1) data structures; and (2) relationships. Intermediate abstractions come into existence or are destroyed depending on how the devices are configured. The requirements database 120 is therefore the set of all intermediate abstractions associated with joint goals for each distributed algorithm in a domain.

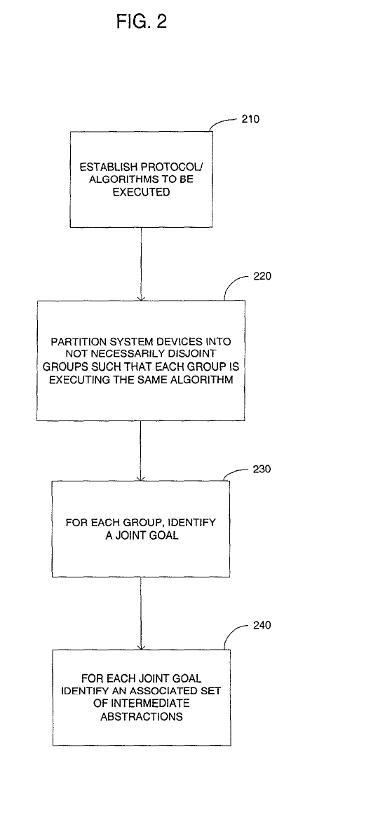

Turning to FIG. 2 there is shown the method steps for decomposing or translating an end-to-end requirement into a set of library requirements. At step 210, a set of distributed algorithms or protocols being executed within the domain and necessary for support of the end-to-end requirement is established. At step 220 the set of system devices are partitioned into not necessarily disjoint groups such that each group is executing the same protocol or algorithm. At step 230 for each such group a joint goal is identified. At step 240 an associated set of intermediate abstractions is identified for each joint goal identified. The end-to-end requirement is then the collection or conjunction of all the intermediate abstractions. Each intermediate abstractions is therefore a library requirement which may be used to express other end-to-end requirements. The method of FIG. 2 is a natural method because intermediate abstractions are typically global in that they span multiple configuration parameters or devices. As such, our method no longer localize instructions to each device as is done in the prior art. By cataloging all abstractions for all such algorithms in database 120, and then by mixing and matching the abstractions in terms of Boolean functions, global, end-to-end requirements can be created for a very large class of systems or networks.

Examples of intermediate abstractions that can be established for devices to achieve joint goals in common protocols include the following:

1. To set up an IPSec (Internet Protocol Security) service between two router interfaces, examples of relationships that must hold are: (1) encryption and has algorithms at the two interfaces must be the same; (b) each interface must point to the other as its tunnel peer; (c) the traffic filters at the two ends should be mirror images of each other; (d) authentication modes at each interface must be identical; and (e) if authentication mode is “preshared”, then the pre-shared keys should be identical.

2. To set up an OSPF (Open Shortest Path First) routing service, the global data structures created are subnets, stubby areas, not so stubby areas, backbone areas or virtual links. Relationships created are route distribution and route summarization. An OSPF service architecture can be defined in terms of these abstractions.

3. To set up BGP service to interconnect autonomous systems, data structures created are confederations and route reflectors. An example of a relationship is redistribution of routes from BGP into an interior gateway protocol such as OSPF.

4. To set up an acknowledgment service via the RMTP-II protocol, an acknowledgement tree (a data structure) has to be set up with the sender at the root, the top node as the only child of the sender and all receivers somewhere in the tree. To set up this tree, each node must be configured with the IP address of its parent.

5. To set up a multicast service using the IGMP protocol, all hosts must have the same multicast address and all routers must be enabled for IGMP (relationships).

Returning to FIG. 1 I will now describe another aspect of my invention, which is the use of the requirements library 120 to build configuration database 150 and to use such a database to diagnose or detect network configuration errors. Provisioning engine 140 is a software function or module that is used for compiling the vendor neutral library requirements or abstractions into detailed device configurations. These detailed device configurations are then forwarded to the configuration database 150. The provisioning engine 140 is also used to change configuration settings of devices in a network to enforce a given requirement in the requirements database 120. The configuration database 150 itself is comprised of data structures having parameter settings or values for the devices that comprise a network and the relationship between the devices. In other words, the configuration database is comprised of vendor neutral configuration parameters.

Diagnosis engine 160 checks whether library requirement, R, is true given a particular device configuration. With respect to the intermediate abstractions themselves the diagnosis engine would perform the following checks: (1) If R is a data structure, does it exist in the requirements database; or (2) If R is a relationship, is that relationship true hold between the affected devices. For example, the diagnosis engine 160 would check if IPSec relationships hold, given the IPSec related configuration parameters at two router interfaces.

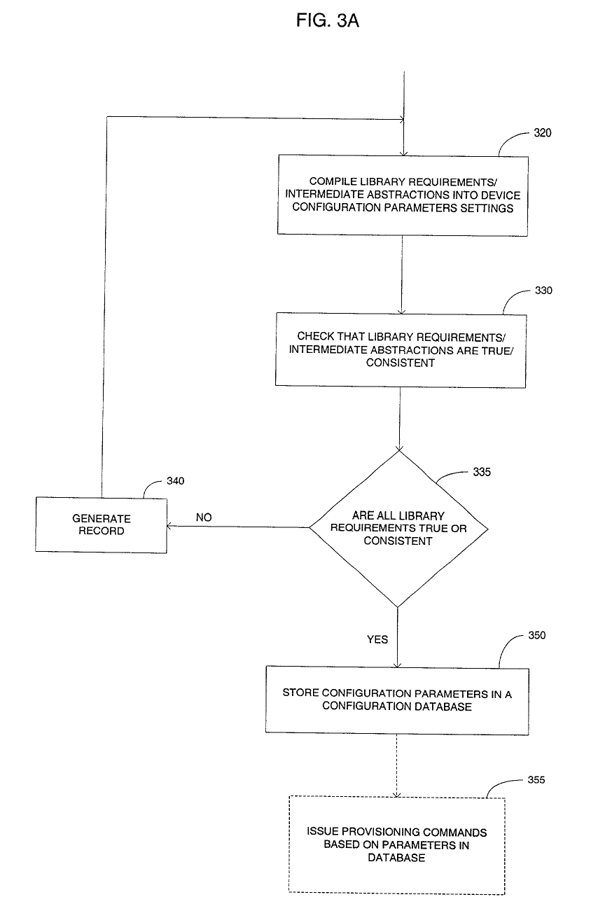

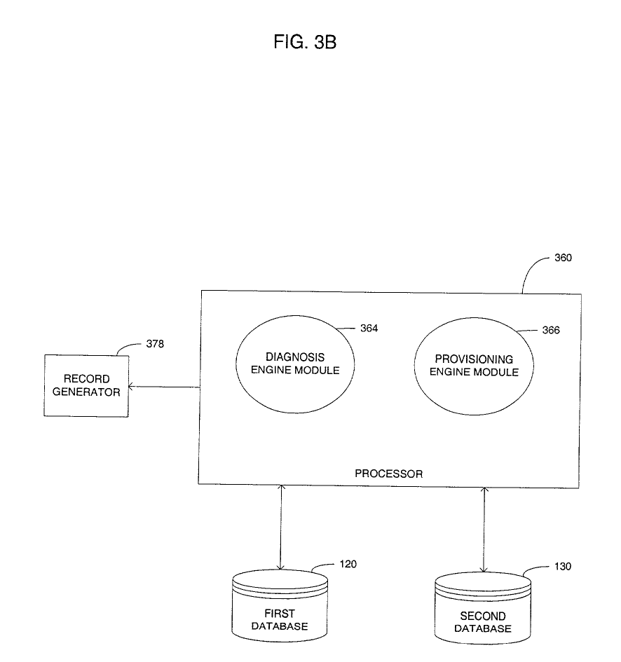

FIG. 3A illustrates the general method steps for implementing our invention in a network. At step 320 the provisioning engine 140 initially takes the vendor neutral library requirements as inputs and compiles these library requirements into unique device configuration settings and forward the settings to the configuration database 150. To guard against possibility that different requirements generate conflicting configuration settings on the devices, at step 330, the diagnosis engine then checks that all the requirements required for the end-to-end requirements are true given the particular configuration settings of devices in a network or system. Step 330 may done be recursively, one library requirement at a time. The result of step 330 is used as the input to decision diamond 335. If any requirement is found to be false a record is generated at step 340 and the process returns to step 310. If the diagnosis engine does find that all the requirements required for the end-to-end requirements are true given the particular configuration settings of devices in a network or system, then the configuration parameters are send to the configuration database at step 350. Form the configuration database, provisioning commands may be issued that set the respective devices to the configuration parameters values in the configuration database thereby establishing the end-to-end service or function at step 355.

As the process outlined in FIG. 3A makes clear the middleware architecture 100 may be thought of as system with decomposed end-to-end service requirements as its inputs and a set of device configuration parameters or values at its output if and only if the end-to-end service requirements are met and the service can be established. This differs from and represents a significant advance over the prior art where the end-to-end requirements resulted in humans or human driven commands setting the configuration parameters in device individually. In accordance with my inventive method a mechanized process is used that sets the device configuration parameters only after a determination is made that such device settings would result in the successful establishment of the end-to-end service or function. In accordance with my invention the practice of configuring devices to meet end-to-end requirements is more efficient and significantly less prone to error which results in a reduction in network operation costs.

Turning to FIG. 3B there is shown a system that may be used to implement the method steps of FIG. 3A. The system comprises a processor 360 having a diagnosis engine module 364 and provisioning engine module 366. The processor 360 is coupled to a first database 120 having the vendor neutral library requirements and a second database 130 having the configuration parameters. The first processor is also coupled to a record generator 378 for generating records relating to the diagnosis engine module 364 results.

To further illustrate my invention I will now show how it may be used to establish services in a virtual private network. The system used in this illustration of my invention was Web-based. The end-to-end service requirements were decomposed into library requirements based on a JAVA application as input to a web site. The provisioning and diagnosis engines comprised of JAVA application programming interfaces (APIs) running on the web site. This illustration shows how to create a virtual private network (VPN) over an Internet service provider (ISP) infrastructure satisfying three requirements: connectivity, security and resilience. The design is based upon and exploits the capabilities of OSPF, IPSec and GRE protocols. All data flows only over tunnels established by the service, but if some tunnels fail, data is rerouted in such a way that it still flows only over secure tunnels.

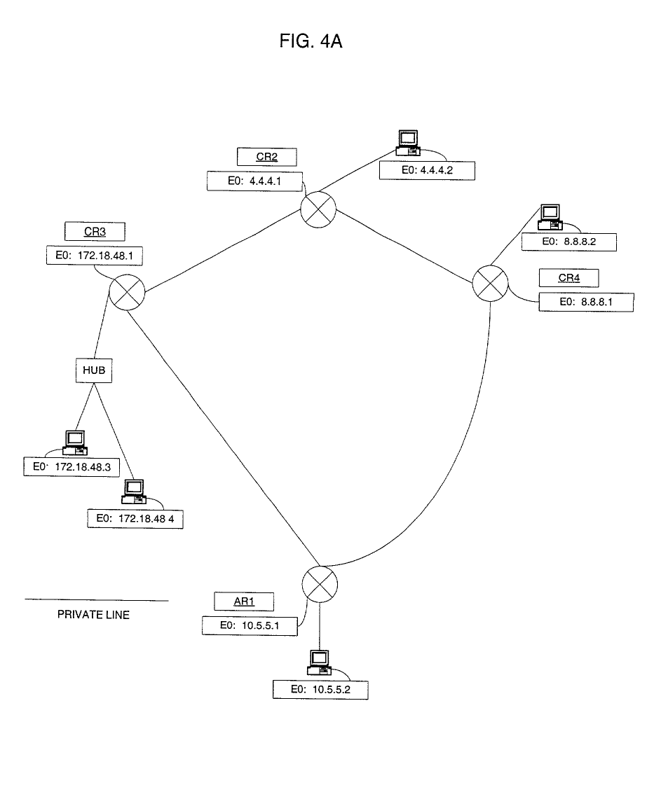

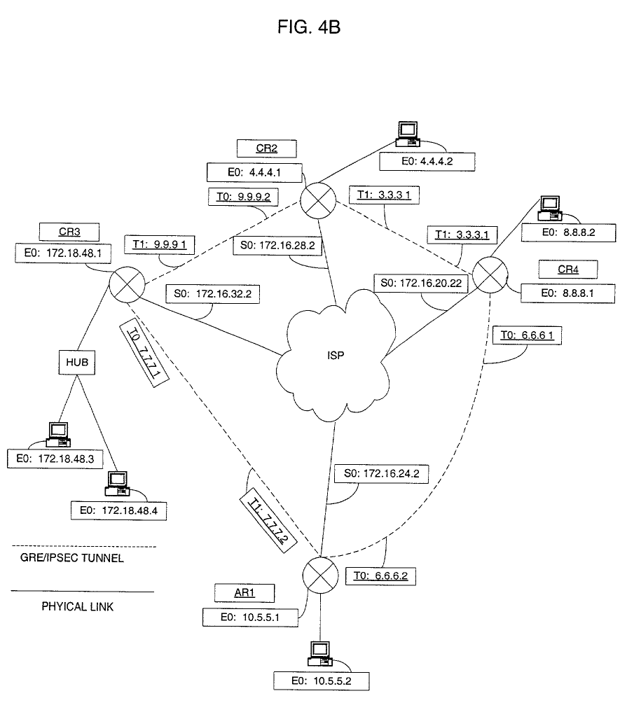

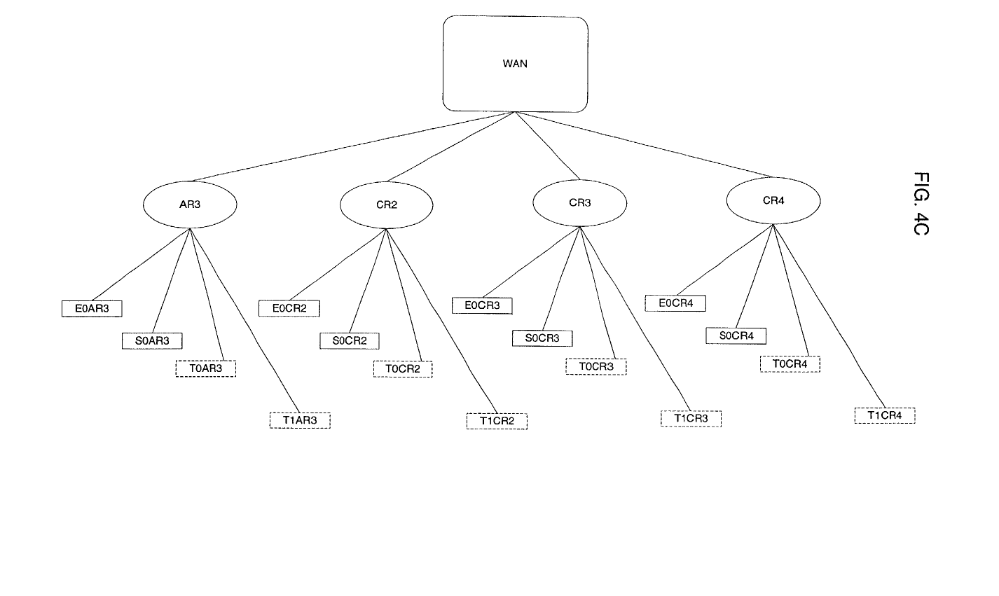

As illustratively depicted in FIG. 4A, a network having multiple locations around the world and gateway routers at each location are linked via private, circuit-switched lines. The network of these lines need not form a full mesh (this one is a ring). Since these lines are dedicated, a certain level of security is ensured. Also, a routing protocol such as OSPF is run at the gateway routers that ensures that traffic is routed from any gateway to any gateway if a path exists. OSPF also ensures resiliency. If a link fails, OSPF calculates a new path from every source to every destination, wherever possible, entirely within the network of private lines.

The decision was made to replace the private lines of the network of FIG. 4A with IPSec tunnels over an ISP's shared infrastructure. The tunnels would ensure strong security. However, routing and resiliency would be seriously affected. IPSec tunnel end points would no longer belong to the same IP subnet so they would no longer be recognized as immediate neighbors by OSPF. Thus, traffic would no longer be automatically routed from one tunnel to the next. To “hook” the tunnels together would require some form of static routing. But static routing neither scales with the number of gateways, nor does it ensure resiliency. If a link fails, alternative routes are not automatically computed. For example, packets from 172.18.48.4 to 8.8.8.2 may be directed along the tunnel at upper left and upper right. However, if interface 172.16.28.2 were to fail e.g., due to an attack, then these packets would be dropped. The alternative route along the lower left and lower right tunnels would not be automatically recomputed. Note that the ISP's routing protocol will not help because it only sees encapsulated packets coming out of CR3, with destination address 172.1628.2.

The solution is shown in the network of FIG. 4B. One first replaces the dedicated lines between gateway routers with GRE tunnels. On each router, new GRE interfaces (T0, T1 in the figure) are created and associated with a physical interface. A GRE interface behaves like a physical interface except that when a packet is routed out of it, it is encapsulated inside another IP packet and routed out of the associated physical port. The destination address of this packet is that of the physical interface associated with the remote GRE tunnel interface. When the packet is received by remote physical interface, it is routed to the associated GRE interface and decapsulated.

An important service provided by GRE is that both end points of a GRE tunnel do appear to be in the same IP subnet. Thus, OSPF processes on routers discover GRE tunnel interfaces as immediate neighbors and operate as if these interfaces were directly connected. Thus, OSPF achieves resiliency as required. In particular, even if interface 172.16.28.2 were to fail, a new route along tunnels at lower left and lower right would be calculated.

To introduce security, one sets up an IPSec tunnel between the two physical interfaces supporting a GRE tunnel. All GRE packets originating at the local physical interface and destined to the remote physical interface are encrypted and vice versa.

The net effect is to create a secure overlay network consisting of the LANs behind the routers and the GRE tunnels. As long as routing processes are aware only of subnets belonging to this overlay network, all traffic between hosts on this network will be routed and rerouted only within this network, in spite of link failures.

Resilience in the above network is now demonstrated. When all three tunnels are operational, then from CR3, traceroute 8.8.8.2 yields:

1. 9.9.9.2

2. 3.3.3.2

3. 8.8.8.2

Now we shutdown 172.16.28.2 CR3 thereby shutting down the tunnel between CR3 and CR2. Issuing traceroute 8.8.8.2 again yields:

1. 7.7.7.2

2. 6.6.6.1

3. 8.8.8.2

i.e., traffic flows via AR1.

However, the above plan for creating the resilient tunnel network cannot today be input into any system and be compiled into device configurations. The compilation is manually performed by experienced network administrators. Table 1 below contains sample configuration parameters of router interfaces and their values. Since these are numerous and the number of devices can be large, a large number of configuration errors can be made and connectivity, security or resilience can be easily compromised.

TABLE 1
Sample Configuration Parameters And Values

| Device | Configuration Parameter | Value |
|---|---|---|
| T1CR3 | 1. IP address | 9.9.9.1 |
| (Interface T1 | 2. Subnet mask | 255.255.255.0 |
| at CR3) | 3. Type | GRE_TUNNEL |
| | 4. OSPF process ID | 10 |
| | 5. OSPF area | 0 |
| | 6. OSPF area type | AREA_REGULAR |
| | 7. GRE peer | 9.9.9.2 |
| | 8. GRE local interface | 172.16.32.2 |
| | 9. GRE remote interface | 172.16.28.2 |
| T0CR2 | 1. IP address | 9.9.9.2 |
| (Interface T0 | 2. Subnet mask | 255.255.255.0 |
| at CR2) | 3. Type | GRE_TUNNEL |
| | 4. OSPF process ID | 10 |
| | 5. OSPF area | 0 |
| | 6. OSPF area type | AREA_REGULAR |
| | 7. GRE peer | 9.9.9.1 |
| | 8. GRE local interface | 172.16.28.2 |
| | 9. GRE remote interface | 172.16.32.2 |
| SOCR3 | 1. IF address | 172.16.32.2 |
| (Interface 80 | 2. Subnet mask | 255.255.255.0 |
| at CR3) | 3. Type | PPP |
| | 4. OSPF process ID | Null |
| | 5. OSPF area | Null |
| | 6. OSPF area type | Null |
| | 7. Encryption algorithm | 3-des |
| | 8. Hash algorithm | md5 |
| | 9. IPSec peer | 172.16.28.2 |
| | 10. Traffic filter | source= 172.16.32.2 |
| | | destination=172.16.28.2 |
| | | protocol = gre |
| | 11. Authentication mode | Preshared keys |
| | 12. Authentication peer | 172.16.28.2 |
| | 13. Preshared key | Tunnel1Key |
| S0CR2 | 1. IP address | 172.16.28.2 |
| (Interface 80 | 2. Subnet mask | 255.255.255.0 |
| at CR2) | 3. Type | PPP |
| | 4. OSPF process ID | Null |
| | 5. OSPF area | Null |
| | 6. OSPF area type | Null |
| | 7. Encryption algorithm | 3-des |
| | 8. Hash algorithm | md5 |
| | 9. IPSec peer | 172.16.32.2 |
| | 10. Traffic filter | source=172.16.28.2 |
| | | destination=172.16.32.2 |
| | | protocol =gre |
| | 11. Authentication mode | Preshared keys |
| | 12. Authentication peer | 172.16.32.2 |
| | 13. Preshared key | Tunnel1Key |

1) IPSec tunnels may be set up incorrectly, for example, the preshared key, hash algorithm, encryption algorithm, authentication modes may be unequal at the two tunnel end points, or the peer values may not be mirror images of each other. This can lead to loss of connectivity. If the wrong traffic filter is used, then sensitive data can be transmitted without being encrypted.

2) OSPF areas may be set up incorrectly, for example, area numbers and stub identifiers, may be unequal at the interfaces intended to be in a given area. This can lead to incorrect routing tables and to outright isolation of subnets.

3) GRE tunnels may be set up incorrectly, for example, the peer values may not be mirror images of each other, or the mapping between GRE ports and physical ports may be incorrect. This can lead to loss of connectivity.

4) If the routing process for gateway router-ISP traffic and the routing process for GRE traffic become aware of each other's networks, then routing loops can occur. Also, sensitive data can be transmitted without being encrypted.

The Requirements Library for the IPSec-based VPN is as follows:

TABLE 2
Service Grammar Requirements Library for Resilient Tunnels

| Type | Requirement | Meaning |
|---|---|---|
| LDAP | node(Name, Type, ParentDN) | In the network database, there is a |
| | | node with name Name and type |
| | | Type which is a direct descendant |
| | | of a node with ParentDN as its |
| | | pointer in the database. |
| Addressing and | subnet(InterfaceList, Type, Mask, | The router interfaces in |
| subnetting | IPAddressList) | InterfaceList form a subnet of |
| | | Layer-2 type Type with mask |
| | | Mask. IP addresses of interfaces in |
| | | InterfaceList are specified in |
| | | IPAddressList. InterfaceList is a |
| | | list of pointers to nodes in the |
| | | configuration database. |
| IPSec | IPSecTunnel(Interface1, Interface2, | An IPSec tunnel has been |
| | IpsecPolicy) | configured between Interface1 |
| | | and Interface2 governed by |
| | | IPSecPolicy. The policy defines |
| | | encryption and hash algorithms, |
| | | the preshared key and traffic |
| | | filters. Traffic filters define what |
| | | IP packets need to be protected. |
| GRE | GRETunnel(Inteface1, Interface2, | A GRE tunnel has been |
| | Physical_Interface1, Physical_Interface2) | configured between GRE |
| | | interface Interface1 and |
| | | Interface2 supported by physical |
| | | interfaces Physical_Interface1 and |
| | | Physical_Interface2 respectively. |
| OSPF | OSPFArea(SubnetList, AreaID, StubFlag) | An OSPF area has been |
| | | configured containing subnets in |
| | | SubnetList with area number |
| | | AreaID and stub type StubFlag |

The above requirements represent a substantial departure from the device centric configuration that is the norm today. For example, to set up an IPSec tunnel, one has to visit each of the tunnel endpoints separately, then configure a large number of parameters and then ensure that settings for both endpoints are consistent. In our case, one can conceptualize the tunnel as a whole. My inventive system computes consistent configuration parameter values for both end points, then applies them. Similarly, for OSPF, GRE and subnetting. Furthermore, these requirements can be combined into higher-level requirements, thereby simplifying the specification and configuration generation process even more.

For each requirement in the above Library, the Diagnosis Engine API defines a procedure of the same name. When executed, this procedure evaluates the requirements against a fixed configuration database.

For each requirement in the above Library, the Provisioning API defines a procedure of the same name, except that it prefixed by setup: setupNode, setupSubnet, setupIPSecTunnel, setupGRETunnel and setupOSPFArea. When these procedures are executed, the configuration database is changed to enforce the associated requirement.

Using the above procedures, we can define a higher level procedure as follows:

Using the above procedures, we can define a higher
level procedure as follows:

setup_encrypted_gre_tunnel(T0, T1, T0Add,
T1Add, P0, P1, Key) =

setupSubnet({T0, T1}, “gre”, “255.255.255.0”, {T0Add, T1Add});
setupGRETunnel(T0, T1, P0, P1);
P0Add = P0.ipAddress;
P1Add = P1.ipAddress;

setupIPSecTunnel(P0, P1, }Key, }“3des”, “md5”},
{{P0Add, P1Add, “gre”}}});

The above procedure sets up a GRE tunnel between two tunnel interfaces T0, T1 with IP addresses T0Add and T1Add, respectively, and two supporting physical interfaces P0, P1. It also sets up an IPSec tunnel with preshared Key between P0 and P1 and encrypts all GRE packets with source address that of P0 and destination address that of P1. The encryption and hash algorithms are, respectively, 3des and md5.

The network of resilient tunnels can be compactly expressed in Java using the Service Grammar Provisioning API. This network has been implemented at Telcordia. Thus, a large class of configuration errors is avoided altogether. All Java declarations have been removed to improve readability. The effect of executing the program is to create a configuration database (as an LDAP directory) and set properties of nodes in it. We assume that nodes for the routers and physical interfaces have already been set up and focus only on additional configuration needed to set up the resilient tunnel network. In FIG. 4C, the initial tree consists of the nodes bounded by solid lines, and the nodes bounded by dashed lines are added by my inventive system and method.

The Java code is as follows:

/*
Create nodes representing GRE tunnel interfaces on the routers and store
pointers to these in variables.
*/
T0CR2 =setupNode(“T0”,GRE_TUNNEL,CR2);
T1CR2 =setupNode(“T1”,GRE_TUNNEL,CR2);
T0CR3 =setupNode(“T0”,GRE_TUNNEL,CR3);
T1CR3 =setupNode(“T1”,GRE_TUNNEL,CR3);
T0CR4 =setupNode(“T0”,GRE_TUNNEL,CR4),
T1CR4 =setupNode(“T1”,GRE_TUNNEL,CR4);
T0AR1 =setupNode(“T0”,GRE_TUNNEL,AR1);
T1AR1 =setupNode(“T1”,GRE_TUNNEL,AR1);
/*
Define variables subnet0. . subnet3 representing Ethernet LANs attached
to the routers. Host interfaces are not included because their configura-
tion is outside the scope of this discussion. Variables subnet4. . subnet7
represent the four GRE subnets.
*/
subnet0 = {E0CR2};
subnet1 = {EOCR3};
subnet2 = {E0AR1};
subnet3 = {E0CR4};
subnet4 = {T0CR3, T1AR1};
subnet5 = {T0AR1, T0CR4};
subnet6 = {T1CR3, T0CR2};
subnet7 = {T1CR2, T1CR4};
/*
Now, to set up the network of resilient tunnels, first define a new OSPF
process with ID 10, and enable it on the LAN and GRE subnets. Put all
these in the same backbone area 0.
*/
setupOSPFA rea(}subnet0, subnet1, subnet2, subnet3, subnet4, subnet5,
subnet6, subnet7}, “10”, “0”, AREA_REGULAR);
/*
Then, set up the four GRE tunnels and IPSec tunnels between associated
physical interfaces.
*/
setupEncryptedGRETunnel(T0CR3, T1AR1, “7.7.7.1”, “7.7.7.2”, S0CR3,
S0AR1, “Tunnel1Key”);
setupEncryptedGRETunnel(T0AR1, T0CR4, “6.6.6.2”, “6.6.6.1”, S0AR1,
S0CR4, “Tunnel2Key”);
setupEncryptedGRETunnel(T1CR3, T0CR2, “9.9.9.1”, “9.9.9.2”, S0CR3,
S0CR2, “Tunnel3Key”);
setupEncryptedGRETunnel(T1CR2, T1CR4, “3.3.3.1”, “3.3.3.2”, S0CR2,
S0CR4, “Tunnel4Key”);

When these calls are executed, values of configuration parameters in directory nodes are set as shown in Table 1 and the resilient tunnel service is set up.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

I claim:

1. A system for configuring networks, the network configuration being based on an end-to-end service requirements, said system comprising:
a database for storing a set of configuration parameters, each configuration parameter relating to a setting on a device in the network;
a database having a set of intermediate abstractions, each of said intermediate abstractions representing a decomposition of the end-to-end service requirement; and
a processor coupled to said configuration database and said intermediate abstractions database, said processor executing the method step of,
compiling the set of intermediate abstractions into configurations parameters.

2. The system of claim 1 wherein said processor further executes the method steps of:
checking said compiled parameters against said library requirements to determine if there inconsistency between said compiled parameters; and
sending said compiled parameters to said configuration parameters database if said checking results in no inconsistencies.

3. A system for diagnosing configuration errors in a network, the network being based on a set of end-to-end service requirements, said system comprising:
a database for storing a set of configuration parameters, each configuration parameter relating to a setting on a device in the network;
a database having a set of intermediate abstractions, each of said intermediate abstractions representing a decomposition of the end-to-end service requirement; and
a processor, coupled to said configuration parameters database and to said intermediate abstractions database, for recursively determining the consistency between the configuration parameters and the intermediate abstractions; and
means coupled to said processor for creating a record of each inconsistency found.

4. The system of claim 3 wherein said intermediate abstractions are expressed as Boolean functions of the configuration parameters.

5. The system of claim 3 wherein said configuration parameter database comprises a LDAP directory having configuration information about all the devices in the network.

6. A method for detecting network configurations errors based on a set of vendor neutral requirements that govern performance in the network, said method comprising the steps of:
creating a set of configuration parameters, each configuration parameter relating to a setting on a device in the network;
recursively determining if said at least one vendor neutral requirement is true based on said created set of configuration parameters; and
creating a record of said at least one translated end-to-end service requirements that were determined to be false, said record representing the diagnosis.

7. The method in accordance with claim 6 the vendor neutral requirements are created by decomposing end-to-end service requirements.

8. A method for configuring networks, the network configuration being based on end-to-end service requirements, said method comprising the steps of:
storing a set of configuration parameters in a database, each configuration parameter relating to a setting on a device in the network;
storing a set of intermediate abstractions in a database, each of said intermediate abstractions representing a decomposition of the end-to-end service requirement; and
compiling the set of intermediate abstractions into configurations parameters.

9. The method of claim 8 further comprising the method steps of:
checking said compiled parameters against said library requirements to determine if there inconsistency between said compiled parameters; and
sending said compiled parameters to said configuration parameters database if said checking results in no inconsistencies.
